(19) United States
(12) Patent Application Publication
(10) Pub. No.: US 2010/0051578 A1
(43) Pub. Date: Mar. 4, 2010

(54) METHOD FOR FABRICATING AN INTEGRATED CIRCUIT

(76) Inventors: Shuo-Che Chang, Taichung County (TW); Yi-Jung Chen, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/365,161

(22) Filed: Feb. 3, 2009

Related U.S. Application Data
(63) Continuation-in-part of application No. 12/246,451, filed on Oct. 6, 2008.

(30) Foreign Application Priority Data
Sep. 4, 2008 (TW) 097133890

(51) Int. Cl. B44C 1/22

(52) U.S. Cl. 216/17

(57) ABSTRACT

A method for fabricating an integrated circuit includes providing a substrate having thereon a material layer; forming trenches in the material layer; forming damascened wires in the trenches; covering the damascened wires and the material layer with a cap layer; forming a through hole in the cap layer that exposes a portion of the material layer; and removing the material layer thereby forming an air gap between the damascened wires.

### CROSS REFERENCE TO RELATED APPLICATIONS

This application is a continuation-in-part of U.S. application Ser. No. 12/246,451 filed Oct. 6, 2008, which is included in its entirety herein by reference.

### BACKGROUND OF THE INVENTION

1. Field of the Invention

The present invention relates, in general, to a method for fabricating an integrated circuit. More particularly, the present invention relates to a method for fabricating an integrated circuit with an air gap.

2. Description of the Prior Art

Semiconductor manufacturers have been trying to shrink transistor size in integrated circuits (IC) to improve chip performance, which leads to the result that the integrated circuit speed is increased and the device density is also greatly increased. However, under the increased IC speed and the device density, the RC delay becomes the dominant factor.

To facilitate further improvements, semiconductor IC manufacturers have been driven by the trend to resort to new materials utilized to reduce the RC delay by either lowering the interconnect wire resistance, or by reducing the capacitance of the inter-layer dielectric (ILD). A significant improvement is achieved by replacing the aluminum (Al) interconnects with copper, which has 30% lower resistivity than that of Al. Further advances are facilitated by improving electrical isolation and reducing parasitic capacitance in high density integrated circuits.

Current attempts to improve electrical isolation and reduce parasitic capacitance in high density integrated circuits involve the implementation of low-k dielectric materials such as FSG, HSQ, SiLK™, FLAREK™. To successfully integrate the low K dielectric materials with conventional semiconductor manufacturing processes, several basic characteristics including low dielectric constant, low surface resistivity (>10¹⁵Ω), low compressive or weak tensile (>30 MPa), superior mechanical strength, low moisture absorption and high process compatibility are required.

While the aforesaid materials respectively have a relatively low dielectric constant, they are not normally used in semiconductor manufacturing process due to increased manufacturing complexity and costs, potential reliability problems and low integration between the low-k materials and metals. Therefore, there is a strong need in this industry to provide a method for fabricating an integrated circuit in order to improve the integrated circuit performance.

### SUMMARY OF THE INVENTION

It is one objective of the present invention to provide an improved method for forming an integrated circuit with air gap in order to solve the above-mentioned conventional problems.

To meet these ends, according to one aspect of the present invention, there is provided a method for fabricating an integrated circuit. A substrate having thereon a first conductive wire and a second conductive wire is provided. A liner layer is formed on the first conductive wire and second conductive wire. An ashable material layer is filled into a space between the first conductive wire and second conductive wire. The ashable material layer is then polished to expose a portion of the liner layer. A cap layer is formed on the ashable material layer and on the exposed liner layer. A through hole is extended into the cap layer to expose a portion of the ashable material layer. Thereafter, the ashable material layer is removed by way of the through hole.

In one aspect, another embodiment of this invention provides a method for fabricating an integrated circuit, comprising the steps of providing a substrate having thereon a material layer; forming trenches in the material layer; forming damascened wires in the trenches; covering the damascened wires and the material layer with a cap layer; forming a through hole in the cap layer that exposes a portion of the material layer; and removing the material layer thereby forming an air gap between the damascened wires.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 8 are schematic, cross-sectional diagrams showing a method for fabricating an integrated circuit in accordance with one preferred embodiment of this invention.

FIG. 9 to FIG. 14 are schematic, cross-sectional diagrams showing a method for fabricating an integrated circuit in accordance with another embodiment of this invention.

### DETAILED DESCRIPTION

Without the intention of a limitation, the invention will now be described and illustrated with reference to the preferred embodiments of the present invention.

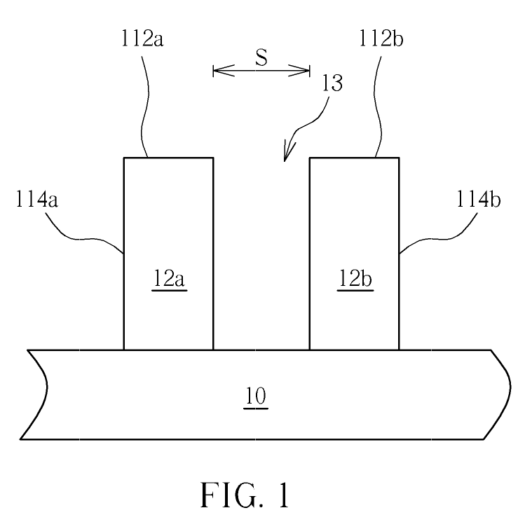

FIG. 1 to FIG. 8 are schematic, cross-sectional diagrams showing a method for fabricating an integrated circuit in accordance with the preferred embodiment of this invention. As shown in FIG. 1, a substrate 10 is provided. A first conductive wire 12a and a second conductive wire 12b are provided on the substrate 10. The first conductive wire 12a is adjacent to the second conductive wire 12b. For example, a space (S) between the first conductive wire 12a and the second conductive wire 12b ranges between 30 nanometers and 500 nanometers. According to this embodiment of the present invention, the first and second conductive wires 12a and 12b are both composed of metal such as aluminum, but not limited thereto.

It is understood that in other embodiments the first and second conductive wires 12a and 12b may be composed of copper or aluminum/copper alloys. According to this embodiment of the present invention, the first conductive wire 12a has an exposed top surface 112a and exposed sidewalls 114a, and the second conductive wire 12b has an exposed top surface 112b and exposed sidewalls 114b.

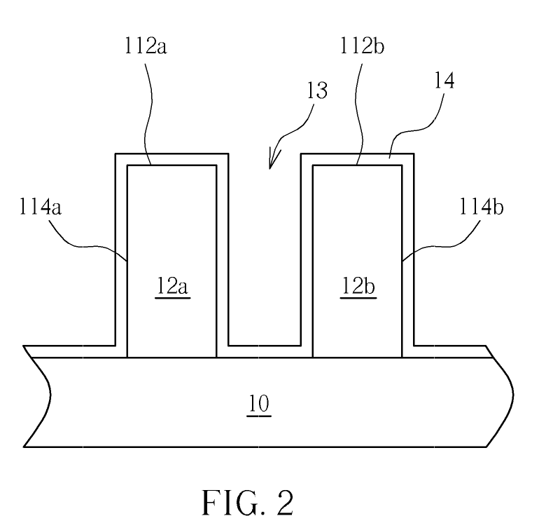

As shown in FIG. 2, subsequently, a chemical vapor deposition (CVD) process is carried out to deposit a conformal liner layer 14 on the top surface 112a and sidewalls 114a of the first conductive wire 12a and the top surface 112b and sidewalls 114b of the second conductive wire 12b. The liner layer 14 also covers the substrate 10.

According to this embodiment of the present invention, the liner layer 14 preferably comprises silicon oxide or silicon nitride and has thickness of 0-1000 angstroms. The thickness of the liner layer 14 is insufficient to fill the space 13 between the first conductive wire 12a and the second conductive wire 12b. In other embodiments, the liner layer 14 may comprise SiO₂, Si₃N₄, SiON, SiC, SiOC, SiCN or any other suitable materials.

According to the preferred embodiment, the liner layer 14 can protect the first conductive wire 12a and the second conductive wire 12b from corrosion. The liner layer 14 also acts as a polishing stop layer during the subsequent chemical mechanical polishing (CMP) process.

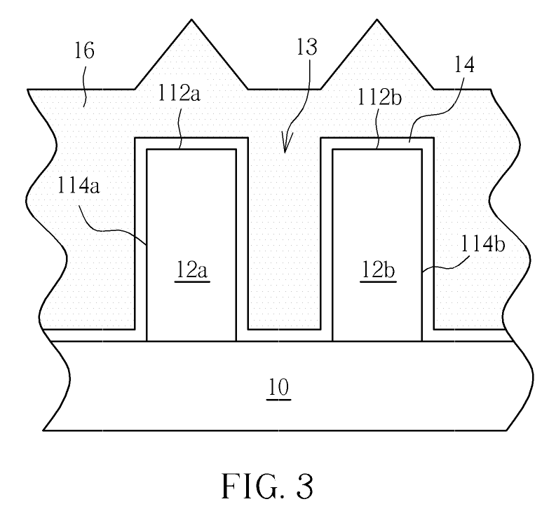

As shown in FIG. 3, an ashable material layer 16 is formed on the liner layer 14. The ashable material layer 16 may comprise carbon layer or fluorine-doped carbon layer. According to the preferred embodiment, the ashable material layer 16 is filled into the space 13 between the first conductive wire 12a and the second conductive wire 12b. The space 13 may be completely or partially filled with the ashable material layer 16. In a situation where the space 13 is not filled with the ashable material layer 16, a void (not shown) may be formed within the space 13.

According to the preferred embodiment of this invention, the ashable material layer 16 may be formed by CVD methods such as PECVD method and HDPCVD method, or spin-on deposition (SOD) methods.

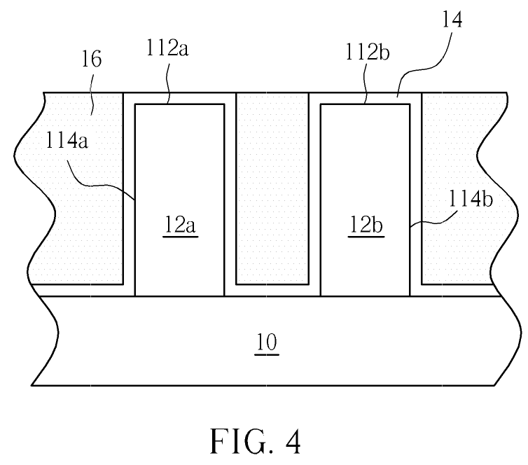

As shown in FIG. 4, subsequently, a planarization process such as CMP process is performed to polish away a portion of the ashable material layer 16, thereby exposing the liner layer 14 on the top surface 112a of the first conductive wire 12a and the liner layer 14 on the top surface 112b of the second conductive wire 12b. As previously mentioned, the liner layer 14 acts as a polishing stop layer during the CMP process. After the CMP process, a top surface of the ashable material layer 16 is substantially coplanar with the exposed surfaces of the liner layer 14.

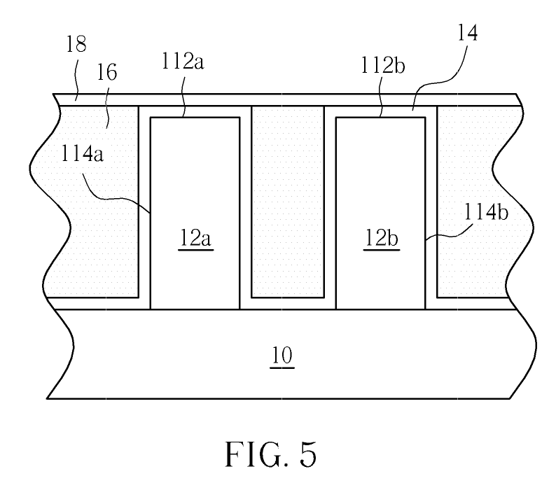

As shown in FIG. 5, a conventional CVD process is carried out to deposit a cap layer 18 on the ashable material layer 16 and on the exposed surfaces of the liner layer 14. According to the preferred embodiment of this invention, the cap layer 18 is a silicon oxide layer. However, the cap layer 18 may be a silicon nitride layer or a low-k dielectric layer.

It is one germane feature of this invention that the ashable material layer 16 in the space 13 must sustain the high temperatures during the CVD deposition of the cap layer 18. Generally, the temperature employed to deposit the cap layer 18 is about 350° C. In this case, the ashable material layer 16 in the space 13 must sustain at least 350° C. In this regard, some organic materials or photoresist materials are inapplicable to the present invention method.

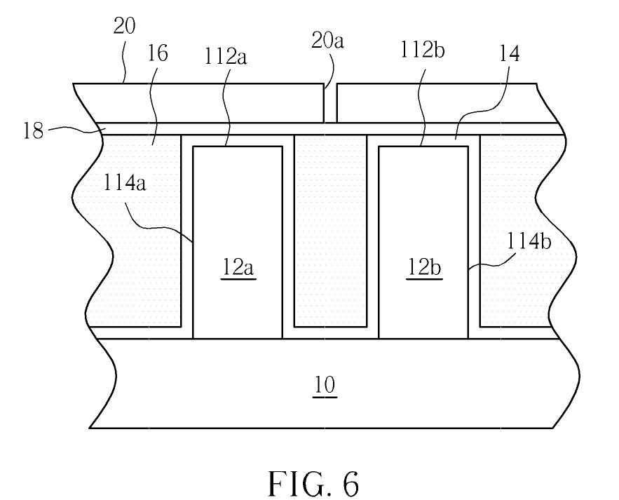

As shown in FIG. 6, a photoresist pattern 20 is formed on the cap layer 18. The photoresist pattern 20 has an aperture 20a exposing a portion of the cap layer 18 directly above the space 13. The method for forming the photoresist pattern 20 may include conventional lithographic process such as photoresist coating, exposure, development and baking.

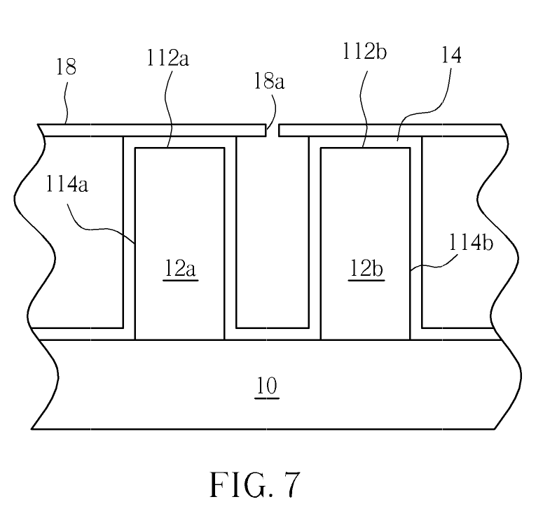

As shown in FIG. 7, thereafter, an etching process such as a dry etching process is performed to etch the cap layer 18 through the aperture 20a of the photoresist pattern 20, thereby forming a through hole 18a in the cap layer 18. The through hole 18a exposes a portion of the ashable material layer 16. The photoresist pattern 20 is then stripped off.

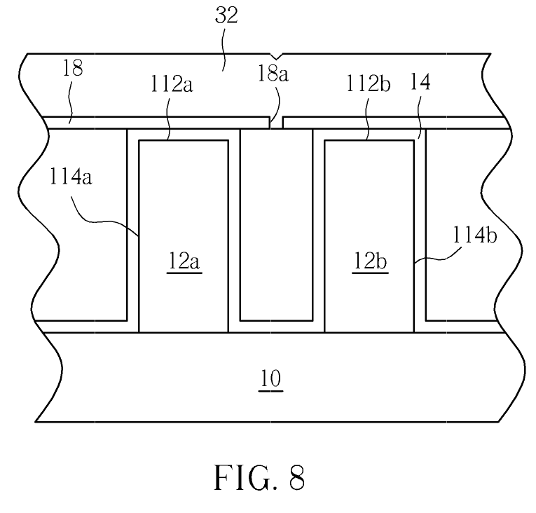

As shown in FIG. 8, an ashing process is carried out. For example, oxygen plasma is utilized to completely remove the ashable material layer 16 between the first conductive wire 12a and the second conductive wire 12b by way of the through hole 18a of the cap layer 18, thereby forming an air gap 30 between the first conductive wire 12a and the second conductive wire 12b. Subsequently, a CVD process is performed to form a dielectric layer 32 over the cap layer 18. The dielectric layer 32 seals the through hole 18a of the cap layer 18 thereby forming a hermetic air gap 30. According to the preferred embodiment of this invention, the dielectric layer 32 may be silicon oxide or low-k dielectric materials. In other embodiments, the deposition of the dielectric layer 32 may be implemented concurrently with the aforesaid ashing process.

The method for fabricating the integrated circuit structure of the present invention has at least the following advantages: (1) The method is completely compatible with current integrated circuit manufacturing processes and no additional investment or development of new equipment is required; (2) The method is cost effective; and (3) The method can provide maximized and unified air gap structure between metal interconnection lines, which is capable of effectively reducing RC delay and improving performance of the integrated circuit device.

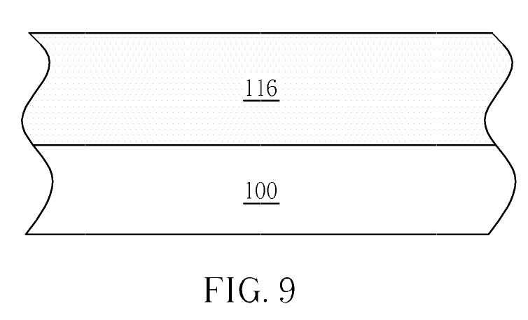

FIG. 9 to FIG. 14 are schematic, cross-sectional diagrams showing a method for fabricating an integrated circuit in accordance with another embodiment of this invention. As shown in FIG. 9, a substrate 100 is provided. The substrate 100 may be a silicon substrate or any suitable semiconductor substrate known in the art. It is to be understood that the substrate 100 may further comprises circuit elements such as transistors or capacitors and dielectric layers or conductive wires overlying the circuit elements, which are not shown for the sake of simplicity. An ashable material layer 116 is formed on a top surface of the substrate 100. The ashable material layer 116 may be made of thermal degradable polymers, carbon or fluorine-doped carbon. Some of the typical thermal degradable polymers are disclosed, for example, in U.S. Pub. No. 2007/0149711 A1 assigned to Dow Global Technologies Inc., which should not be used to limit the scope of the invention.

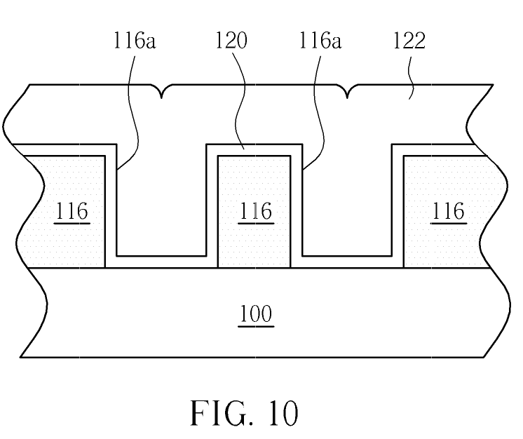

Subsequently, as shown in FIG. 10, trenches 116a are formed in the ashable material layer 116. Each of the trenches 116 exposes a portion of the underlying substrate 100. The trenches 116a may be line-shaped trenches or via holes. It is noteworthy that although only the exemplary single damascene process is shown through FIG. 9 to FIG. 14, the present invention may be applicable to dual damascene processes or any other types of copper damascene process. After the formation of the trenches 116a, a diffusion barrier layer 120 such as Ta/TaN or Ti/TiN is deposited on interior surface of the trenches 116a and on the top surface of the ashable material layer 116. A low-resistance metal layer 122 such as copper is then deposited on the diffusion barrier layer 120 and fills the trenches 116a.

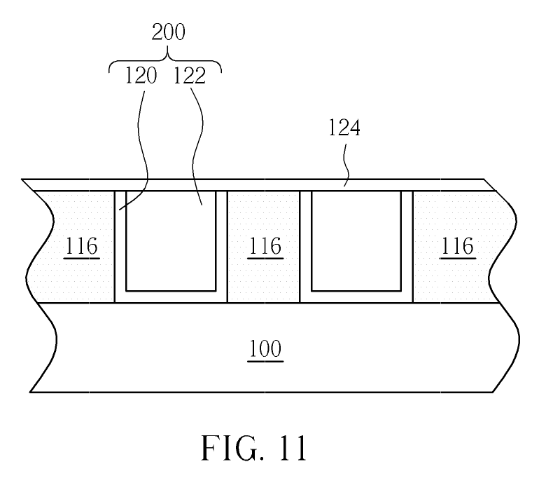

As shown in FIG. 11, a conventional chemical mechanical polishing (CMP) process is then carried out to polish the low-resistance metal layer 122 until the low-resistance metal layer 122 and the diffusion barrier layer 120 directly above the top surface of the ashable material layer 116 are completely removed. After CMP, the remanent low-resistance metal layer 122 and the diffusion barrier layer 120 damascened in the trenches 116a constitute damascened interconnection wires 200. Each of the damascened interconnection wires 200 has a top surface that is substantially flush with the top surface of the ashable material layer 116.

Thereafter, a cap layer 124 is deposited on the substrate to cover the damascened interconnection wires 200 and the ashable material layer 116. Suitable materials for the cap layer 124 include but not limited to SiOC, SiO₂, Si₃N₄, SiCN, SiC.

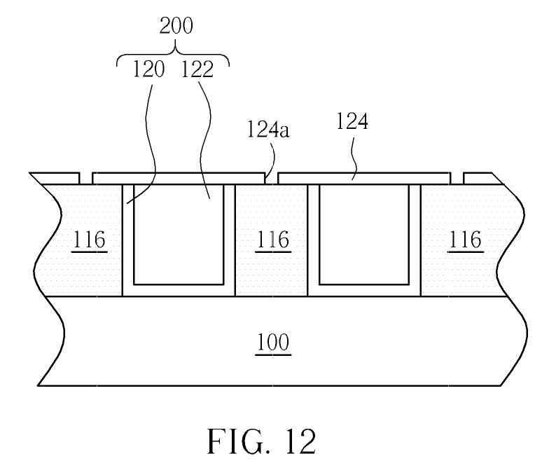

As shown in FIG. 12, a conventional photolithographic process and etching process are performed to form through holes 124a in the cap layer 124. The aforesaid photolithographic process may include photoresist coating and baking, exposure and development. Each of the through holes 124a exposes a portion of the ashable material layer 116 between the damascened interconnection wires 200 and does not expose any of the damascened interconnection wires 200.

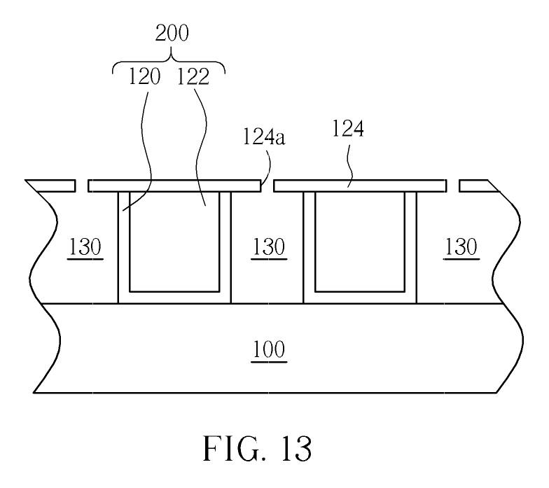

As shown in FIG. 13, using the cap layer 124 as a protection layer that protects the top surface of the damascened interconnection wires 200, an oxygen plasma etching process is performed to etch and remove the ashable material layer 116, thereby forming air gaps 130 between the damascened interconnection wires 200.

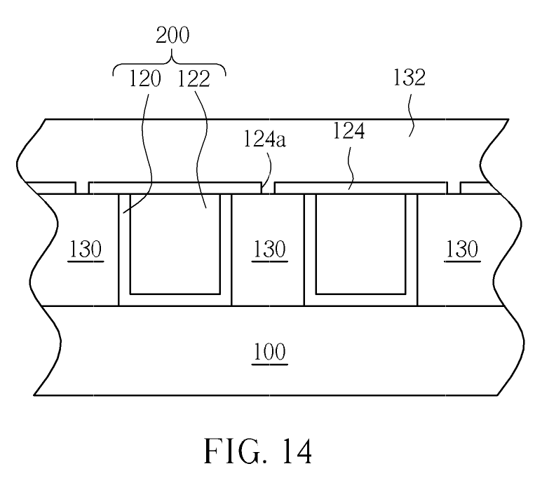

As shown in FIG. 14, subsequently, a CVD process is performed to form a dielectric layer 132 over the cap layer 124. The dielectric layer 132 seals the through hole 124a of the cap layer 124 thereby forming a substantially hermetic air gap 130. According to the preferred embodiment of this invention, the dielectric layer 132 may be silicon oxide or low-k dielectric materials. In other embodiments, the deposition of the dielectric layer 132 may be implemented concurrently with the aforesaid ashing process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for fabricating an integrated circuit, comprising the steps of:
providing a substrate having thereon a material layer;
forming trenches in the material layer;
forming damascened wires in the trenches;
covering the damascened wires and the material layer with a cap layer;
forming a through hole in the cap layer that exposes a portion of the material layer; and
removing the material layer thereby forming an air gap between the damascened wires.

2. The method of claim 1, wherein the cap layer is selected from a group consisting of SiO₂, Si₃N₄, SiON, SiC, SiOC and SiCN.

3. The method of claim 1, wherein the material layer is selected from a group consisting of thermal degradable polymers, carbon and fluorine-doped carbon.

4. The method of claim 1, wherein the material layer is removed by using oxygen plasma.

5. The method of claim 1, further comprising the following step after the material layer removing step:
forming a dielectric layer over the substrate to seal the air gap.

6. The method of claim 5, wherein the dielectric layer selectively comprises silicon oxide and low-k dielectric materials.
